(19) United States
(12) Patent Application Publication
(10) Pub. No.: US 2022/0212339 A1
(43) Pub. Date: Jul. 7, 2022

(54) ACTIVE DATA LEARNING SELECTION METHOD FOR ROBOT GRASP

(71) Applicant: DALIAN UNIVERSITY OF TECHNOLOGY, Dalian (CN)

(72) Inventors: Xin YANG, Dalian (CN); Boyan WEI, Dalian (CN); Baocai YIN, Dalian (CN); Qiang ZHANG, Dalian (CN); Xiaopeng WEI, Dalian (CN); Zhenjun DU, Dalian (CN)

(21) Appl. No.: 17/564,588

(22) Filed: Dec. 29, 2021

(30) Foreign Application Priority Data
Jan. 4, 2021 (CN) 202110001555.8

(51) Int. Cl. B25J 9/16

(52) U.S. Cl. CPC B25J 9/161; B25J 9/1697; B25J 9/1612; B25J 9/163

(57) ABSTRACT

The present invention belongs to the technical field of computer vision and provides a data active selection method for robot grasping. The core content of the present invention is a data selection strategy module, which shares the feature extraction layer of backbone main network and integrates the features of three receptive fields with different sizes. While making full use of the feature extraction module, the present invention greatly reduces the amount of parameters that need to be added. During the training process of the main grasp method detection network model, the data selection strategy module can be synchronously trained to form an end-to-end model. The present invention makes use of naturally existing labeled and unlabeled labels, and makes full use of the labeled data and the unlabeled data. When the amount of the labeled data is small, the network can still be more fully trained.

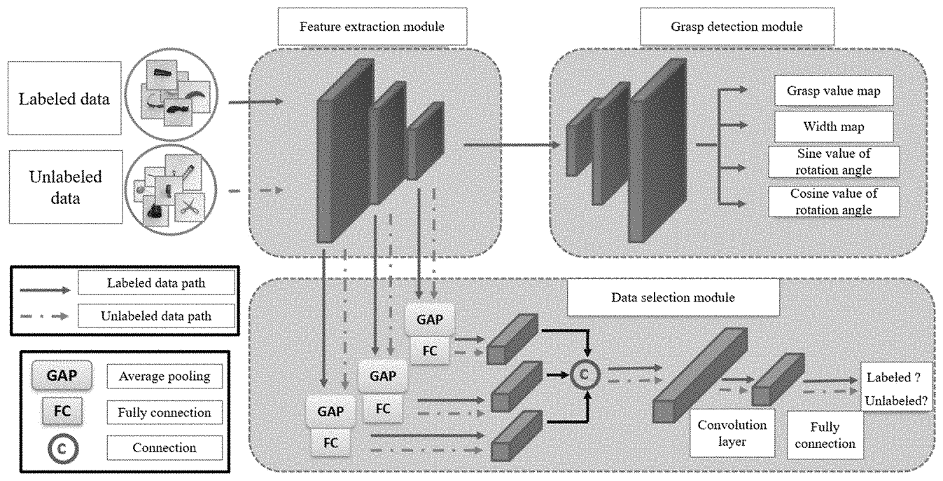

### TECHNICAL FIELD

The present invention belongs to the technical field of computer vision, and in particular relates to a method for using active learning to reduce the cost of data labeling based on deep learning.

### BACKGROUND

Robot grasp method detection is a computer vision research topic with important application significance. It aims to analyze the grasp methods of objects included in a given scene and select the best grasp method for grasp. With the significant development of Deep Convolutional Neural Networks (DCNNs) in the field of computer vision, their excellent learning capabilities have also been widely used in the study of detection of robot grasp methods. However, compared with general computer vision problems, such as target detection, semantic segmentation, etc., robot grasp method detection has two indispensable requirements. One is the real-time requirement of this task. If the real-time detection effect cannot be achieved, the method is of no application value. The other is the learning cost of the task in an unfamiliar environment. There are many kinds of objects in different environments. If a method is to be better applied to an unfamiliar environment, it is necessary to reacquire the data, label the data and train the data to obtain satisfied detection results.

Current deep learning methods require a large amount of labeled data for training. However, these labeled data have redundancies that cannot be judged artificially, and the annotator cannot judge which piece of data can better improve the performance of the deep learning network. Active learning aims to use strategies to select the most informative data from unlabeled data, and provide it to the annotator for labeling, so as to compress the amount of data that needs to be labeled as much as possible, while ensuring the training effect of the deep learning network, thereby reducing the cost of labeling data. The concept of active learning fits well with the second requirement of robot grasp method detection, which provides an effective guarantee for the migration of methods of robot grasp method detection in unfamiliar environments. Next, the relevant background technology in robot grasp method detection and active learning is introduced in detail.

### (1) Robot Grasp Method Detection

Detection of Grasp Method Based on Analytical Method

The analysis method for detecting the object grasp method mainly uses the mathematical and physical geometric models of the object, combined with dynamics and kinematics to calculate the stable grasp method of the current object. However, because the interaction between a mechanical gripper and the object is difficult to model the object, this detection method has not achieved good results in real-world applications.

Detection of Grasp Method Based on Empirical Method

The empirical method for detection of the object grasp method focuses on the use of object models and experience-based methods. Among them, a part of the work uses object models to establish a database to associate known objects with effective grasp methods. When facing the current object, similar objects are searched in the database to obtain the grasp method. Compared with the analysis method, this method has a relatively better application effect in the real world task, but still lacks the generalization ability for the unknown objects.

Detection of Grasp Method Based on Deep Learning

Deep learning methods have been proven to play a huge role in visual tasks. For the detection of the grasp methods of the unknown objects, algorithms based on deep learning have also made a lot of progress. The mainstream grasp method is expressed as a rectangular box similar to target detection. However, this rectangular box has a rotation angle parameter. Using the coordinates of the center point of the rectangular box, the width of the rectangular box, and the rotation angle of the rectangular box, a unique grasp posture can be expressed. Most of the grasp method detection algorithms so far follow a general detection process: detecting candidate grasp positions from image data, using convolutional neural networks to evaluate each candidate grasp position, and finally selecting the grasp position with the highest evaluation value as output. One of the representative methods is the object capture method detection model modified based on the target detection model Fast RCNN proposed by Chu et al. This method has a large amount of network model parameters and relatively low real-time performance. Morrison et al. proposed a pixel-level object capture method detection model based on a full convolutional neural network, and output four images equal in size to the original image, which are the captured value map, the width map, and the sine map and the cosine graph value of the rotation angle. The model has few parameters and high real-time performance. The detection of grasp methods based on deep learning has good effects in actual scenes and has strong generalization ability to unknown objects.

Even though the grasp method detection based on deep learning has made remarkable progress, the method is still limited by deep learning's large demand for data. There are two main aspects: one is to conduct training in the traditional way; if there is no sufficient labeled data, the network model cannot obtain satisfactory accuracy; second, when the existing model is migrated to the problem of detecting strange objects, it will consume a lot of manpower to collect and label the strange objects. The active learning technology introduced next provides a solution to the problem of data labeling.

### (2) Active Learning Strategy

The core of active learning is a data selection strategy. This strategy selects a part of the data from an unlabeled data pool, provides it to the annotator for labeling, adds the labeled data to the labeled data pool, and uses this part of the data to train the network. The intention of active learning is to use the method of labeling part of the data to obtain the network model training effect that can be achieved by labeling all the data. Current active learning strategies are mainly divided into two categories, one is model-based active learning strategies, and the other is data-based active learning strategies.

Model-Based Active Learning Strategy

Model-based active learning strategies mainly use some parameters generated by the deep learning network models as data selection criteria. The more representative one is the uncertainty strategy proposed by Settles, which uses the category probability vector output by the classification network model to calculate the uncertainty, and data with higher uncertainty is considered more valuable. This method is only suitable for classification problems and cannot be extended to regression problems. Yoo et al. proposed a method to use the loss function value in the training process of the deep learning network model as a criterion for screening the data. The larger the loss function value is, the more the data information is. This method has nothing to do with the output of the network model, so it can be applied to the classification problems and the regression problems.

Data-Based Active Learning Strategy

Data-based active learning strategies focus on the distribution of the data, hoping to obtain the most representative data from the distribution of the data. One of the representative ones is the graph density algorithm proposed by Ebert et al. This algorithm uses the number and similarity of data similar to each data to calculate the graph density of each data. The higher the graph density is, the more representative the data is. This method is completely unrelated to the network model, so it can be applied to the classification problems and the regression problems.

The detection method of the grabbing method involved in the present invention is a pure regression problem and has high real-time requirements. The active learning strategies mentioned above all have limitations. They either cannot be applied to the regression problems, or the amount of calculation is too large, and even larger than the grabbing method detection model.

### SUMMARY

Aiming at the problem of low-cost and rapid migration of the robot grasp method detection method in an unfamiliar environment, the present invention designs an active data selection method for robot grasp, which can select the most informative data from a large amount of unlabeled data and only needs to label the selected data, and will not reduce the effect of network training, thereby greatly reducing the cost of data labeling. Moreover, the method is end-to-end, and can be trained at the same time as the network.

The technical solution of the present invention is as follows:

An active data selection method for robot grasp is mainly divided into two branches: an object grasp method detection branch and a data selection strategy branch. The overall structure can be expressed as shown in the sole FIGURE. It specifically includes the following three modules:

(1) Data Feature Extraction Module

The structure of the module is a simple convolutional neural network feature extraction layer. After the input data is processed by the feature extraction module, it will be called feature data and provided to other modules for use.

### (1.1) Module Input:

The input of this module can be freely selected between RGB image and depth image. There are three input schemes: a single RGB image, a single depth image and a combination of RGB and depth image. The corresponding input channels are 3 channels, 1 channel and 4 channels respectively. The length and width of the input image are both 300 pixels;

### (1.2) Module Structure:

this module uses a three-layer convolutional neural network structure; the sizes of the convolution kernel are 9×9, 5×5 and 3×3; the number of output channels is 32, 16 and 8 respectively; each layer of the data feature extraction module is composed of convolutional layers and activation functions, and the whole process is expressed as the following formulas:

Out1=F(RGBD) (1)

Out2=F(Out1) (2)

Out3=F(Out2) (3)

RGBD represents the 4-channel input data combining RGB image and the depth image, and F represents the combination of the convolutional layer and the activation functions, Out1, Out2 and Out3 represent the feature maps of the three-layer output; when the length and width of the input image are both 300 pixels, the size of Out1 is 100 pixels×100 pixels, the size of Out2 is 50 pixels×50 pixels, and the size of Out3 is 25 pixels×25 pixels;

(2) grasp method detection module

this module uses a final feature map obtained by the data feature extraction module to perform deconvolution operation to restore the feature map to the original input size, which is 300 pixels×300 pixels, and obtain the final result, namely a grasp value map, a width map and sine and cosine diagrams of the rotation angle; according to these four images, the center point, width and rotation angle of the object grasp method are obtained;

(2.1) module input:

the input of this module is the feature map Out3 obtained in formula (3);

(2.2) module structure:

the grasp method detection module contains three deconvolution layers and four separate convolutional layers; the sizes of the convolution kernels of the three deconvolution layers are set to 3×3, 5×5 and 9×9; the sizes of the convolution kernels of the four separate convolutional layers is 2×2; in addition, after the deconvolution operation, each layer also comprises the ReLU activation function to achieve a more effective representation, and the four separate convolutional layers will directly output the result; the process is expressed as:

x=DF(Out3) (4)

p=P(x) (5)

w=W(x) (6)

s=S(x) (7)

c=C(x) (8)

Out3 is the final output of the feature extraction layer, DF is the combination of three deconvolution layers and the corresponding activation function ReLU; P, W, S, and C represent four separate deconvolution layers, and correspondingly p, w, s and c respectively represent the final output capture value map, width map, and the sine and cosine diagram of the rotation angle; the final capture method is expressed by the following formulas:

$$\begin{matrix}( i , j ) = argmax ( p ) & ( 9 ) \\ width = w ( i , j ) & ( 10 ) \\ sin θ = s ( i , j ) & ( 11 ) \\ cos θ = c ( i , j ) & ( 12 ) \\ θ = arctan ( \frac{sin θ}{cos θ} ) & ( 13 )\end{matrix}$$

argmax represents the horizontal and vertical coordinates (i,j) of the maximum point in the FIGURE; the width width, the sine value of the rotation angle sin θ and the cosine value of the rotation angle cos θ are respectively obtained from the corresponding output image and the above coordinates, and the final rotation angle θ is obtained by the arctangent function arctan;

(3) data selection module

the data selection module shares all the feature maps obtained by the data feature extraction module, and uses these feature maps to obtain the final output; the output is between 0 and 1, which represents the probability that the input data is labeled data; the closer the value is to 0, it means the probability that the data has been labeled is smaller, so this labeled data should be selected less likely;

(3.1) module input:

the input of this module is the combination of Out1, Out2 and Out3 obtained by formulas (1), (2) and (3);

(3.2) module structure:

since the feature maps obtained by the data feature extraction module are of different sizes, this module first uses the average pooling layer to perform dimensionality reduction operations on the feature maps; according to the number of channels of the three feature maps, they are reduced into feature vectors with 32, 16 and 8 channels respectively; after that, each feature vector goes through a fully connected layer separately, and outputs a vector of length 16; three vectors of length 16 are connected and merged to obtain a vector of length 48; in order to better extract features, a vector with a length of 48 is input to a convolutional layer and an activation function ReLU, and the number of output channels is 24; the vector with a length of 24 finally passes through the fully connected layer to output the final result value; the process is expressed as the following formulas:

f1=FC(GAP(Out1)) (14)

f2=FC(GAP(Out2)) (15)

f3=FC(GAP(Out3)) (16)

k=F(f1+f2H+f3) (17)

GAP represents the global average pooling layer, FC represents the fully connected layer, + represents the connection operation, F represents the combination of the convolutional layer, the activation function ReLU and the fully connected layer, and k is the final output value.

The present invention has the following beneficial effects:

(1) Embedded Data Selection Strategy Module

The core content of the present invention is a data selection module, which shares the feature extraction layer of a backbone network and integrates the features of three receptive fields with different sizes. While making full use of the feature extraction module, the present invention greatly reduces the amount of parameters that need to be added. In the training process of the main grasp method detection network model, the data selection strategy module can be synchronized trained to form an end-to-end model.

(2) Making Full Use of all Data

Compared with other active learning strategies, the strategy of the present invention does not only focus on the labeled data, but uses the naturally existing labeled and unlabeled labels, and makes full use of the labeled data and unlabeled data. When the amount of the labeled data is small, the network can still be fully trained.

### DESCRIPTION OF DRAWINGS

The sole FIGURE is a diagram of the neural network structure of the present invention. The FIGURE contains three modules, namely a feature extraction module, a grasp method detection module and a data selection module.

### DETAILED DESCRIPTION

The present invention is further described in detail below in combination with specific embodiments, but the present invention is not limited to the specific embodiments.

An active data learning selection method for robot grasp includes training, testing and data selection stages of a main network model and an active learning branch network.

(1) Network Training

For the main network part, that is, a feature extraction module and a grasp method detection module, the adaptive moment estimation algorithm (Adam) is used to train the entire network, and the branch network, i.e., the data selection strategy module part, is trained using the stochastic gradient descent algorithm (SGD). The batch size is set to 16, that is, 16 data are selected from the labeled data, and 16 data are selected from the unlabeled data each time. The labeled data is propagated forward through the feature extraction module and the grasp method detection module, and finally the labeled label is used to obtain the loss function value. Here, the mean square error loss function (MSELoss) is used. The front-phase propagation of the unlabeled data passes through the feature extraction module and the data selection module, and finally uses the natural labeled and unlabeled labels to obtain the loss function value. The two-class cross entropy loss function (BCELoss) is used. The above two loss function values are added with coefficients 1 and 0.1 respectively to obtain the joint loss function value of one training.

(2) Network Testing

In the testing process, the labeled test set is used to test the accuracy of the grasp detection results of the main network. The data in the test set will ignore the data selection strategy module, and only forward it in the main network to obtain the final result. For each data in the test set, there are only accurate and inaccurate results, namely 1 and 0 results. The final accuracy is represented by the ratio of the sum of the predicted results to the size of the test set.

(3) Data Selection

After the current network effect is tested, if the current effect still does not meet expectations, further data selection can be made. All the unlabeled data will ignore the grasp method detection module, and the forward propagation will pass through the feature extraction module and the data selection strategy module, and finally the probability value of each data will be obtained. The data is sorted from smallest to largest probability value, and the first n data are taken (n is the amount of custom data) for labeling, and added to the labeled data pool. The above process is repealed, and retraining is conducted.

1. An active data learning selection method for robot grasp, which is mainly divided into two branches, an object grasp method detection branch and a data selection strategy branch, which specifically comprises the following three modules:
(1) data feature extraction module
The data feature extraction module is a convolutional neural network feature extraction layer; after the input data is processed by the data feature extraction module, the input data is called feature data and provided to other modules for use;
(1.1) module input:
the input of this module can be freely selected between RGB image and a depth image; there are three input schemes: a single RGB image, a single depth image and a combination of RGB and the depth image; the corresponding input channels are 3 channels, 1 channel and 4 channels respectively; the length and width of the input image are both 300 pixels;
(1.2) module structure:
This module uses a three-layer convolutional neural network structure; the sizes of the convolution kernel are 9×9, 5×5 and 3×3; the number of output channels is 32, 16 and 8 respectively; each layer of the data feature extraction module is composed of convolutional layers and activation functions, and the whole process is expressed as the following formulas:
Out1=F(RGBD) (1)
Out2=F(Out1) (2)
Out3=F(Out2) (3)
RGBD represents the 4-channel input data combining RGB image and the depth image, and F represents the combination of the convolutional layer and the activation functions, Out1, Out2 and Out3 represent the feature maps of the three-layer output; when the length and width of the input image are both 300 pixels, the size of Out1 is 100 pixels×100 pixels, the size of Out2 is 50 pixels×50 pixels, and the size of Out3 is 25 pixels×25 pixels;
(2) grasp method detection module
This module uses a final feature map obtained by the data feature extraction module to perform deconvolution operation to restore the feature map to the original input size, which is 300 pixels×300 pixels, and obtain the final result, namely a grasp value map, a width map and sine and cosine diagrams of the rotation angle; according to these four images, the center point, width and rotation angle of the object grasp method are obtained;
(2.1) module input:
The input of this module is the feature map Out3 obtained in formula (3);
(2.2) module structure:
The grasp method detection module contains three deconvolution layers and four separate convolutional layers; the sizes of the convolution kernels of the three deconvolution layers are set to 3×3, 5×5 and 9×9; the sizes of the convolution kernels of the four separate convolutional layers is 2×2; in addition, after the deconvolution operation, each layer also comprises the ReLU activation function to achieve a more effective representation, and the four separate convolutional layers will directly output the result; the process is expressed as:
x=DF(Out3) (4)
p=P(x) (5)
w=W(x) (6)
s=S(x) (7)
c=C(x) (8)
Out3 is the final output of the feature extraction layer, DF is the combination of three deconvolution layers and the corresponding activation function ReLU; P, W, S, and C represent four separate deconvolution layers, and correspondingly p, w, s and c respectively represent the final output capture value map, width map, and the sine and cosine diagram of the rotation angle; the final capture method is expressed by the following formulas:
$$\begin{matrix}( i , j ) = argmax ( p ) & ( 9 ) \\ width = w ( i , j ) & ( 10 ) \\ sin θ = s ( i , j ) & ( 11 ) \\ cos θ = c ( i , j ) & ( 12 ) \\ θ = arctan ( \frac{sin θ}{cos θ} ) & ( 13 )\end{matrix}$$
argmax represents the horizontal and vertical coordinates (i,j) of the maximum point in the FIGURE; the width width, the sine value of the rotation angle sine and the cosine value of the rotation angle cos θ are respectively obtained from the corresponding output image and the above coordinates, and the final rotation angle θ is obtained by the arctangent function arctan;
(3) data selection module
The data selection module shares all the feature maps obtained by the data feature extraction module, and uses these feature maps to obtain the final output; the output is between 0 and 1, which represents the probability that the input data is labeled data; the closer the value is to 0, it means the probability that the data has been labeled is smaller, so this labeled data should be selected less likely;
(3.1) module input:
The input of this module is the combination of Out1, Out2 and Out3 obtained by formulas (1), (2) and (3);
(3.2) module structure:
since the feature maps obtained by the data feature extraction module are of different sizes, this module first uses the average pooling layer to perform dimensionality reduction operations on the feature maps; according to the number of channels of the three feature maps, they are reduced into feature vectors with 32, 16 and 8 channels respectively; after that, each feature vector goes through a fully connected layer separately, and outputs a vector of length 16; three vectors of length 16 are connected and merged to obtain a vector of length 48; in order to better extract features, a vector with a length of 48 is input to a convolutional layer and an activation function ReLU, and the number of output channels is 24; the vector with a length of 24 finally passes through the fully connected layer to output the final result value; the process is expressed as the following formulas:
f1=FC(GAP(Out1)) (14)
f2=FC(GAP(Out2)) (15)
f3=FC(GAP(Out3)) (16)
k=F(f1+f2+f3) (17)
GAP represents the global average pooling layer, FC represents the fully connected layer, + represents the connection operation, F represents the combination of the convolutional layer, the activation function ReLU and the fully connected layer, and k is the final output value.
